(19) United States
(12) Patent Application Publication
(10) Pub. No.: US 2026/0227908 A1
(43) Pub. Date: Aug. 6, 2026

(54) Operation Type Concurrency In Data Storage Environments

(71) Applicant: NetApp, Inc., San Jose, CA (US)

(72) Inventors: Dheeraj Raghavender Sangamkar, Surrey (CA); Michal Jakub Dacko, Vancouver (CA)

(73) Assignee: NetApp, Inc., San Jose, CA (US)

(21) Appl. No.: 19/181,626

(22) Filed: Apr. 17, 2025

Related U.S. Application Data
(60) Provisional application No. 63/754,111, filed on Feb. 5, 2025.

(51) Int. Cl. G06F 3/06

(52) U.S. Cl. CPC G06F 3/0611; G06F 3/0631; G06F 3/067

(57) ABSTRACT

Improved techniques for using multicore processors to process storage operations for multithreaded applications. Operation type concurrency is considered for storage operations in a storage system in addition to application concurrency. A storage controller of the storage system identifies a storage operation associated with an application and an available worker thread for processing the storage operation. The storage controller determines whether to use the available worker thread to execute the storage operation based on an application concurrency limit for the application and an operation type concurrency limit for the operation type of the storage operation. The storage controller allocates a worker thread to a storage operation only where the storage operation does not satisfy either limit. By evaluating and limiting the concurrency of specific operation types, the storage system mitigates response latency resulting from a large volume of storage operations of a particular type consuming a disproportionate amount of computing resources.

### TECHNICAL FIELD

Aspects of the disclosure are related to the field of data storage solutions and, in particular, to the concurrent processing of application workloads.

### BACKGROUND

In the context of data storage environments, a storage controller plays an important part in managing the overall operations of a data storage system. A storage controller acts as a coordination point that ensures I/Os are properly processed. Modern storage controllers are often equipped with multicore processor(s). Multicore processors allow data storage controllers to handle multiple tasks simultaneously (e.g., the parallel execution of reads, writes, and deletes).

Application concurrency, in this context, refers to the ability to allocate multiple threads to different workloads. The storage controller can leverage the threads in the multicore process(s) to handle multiple read, write, and delete operations at the same time. However, a high level of concurrency can introduce challenges in efficiently processing I/O operations. For example, delete operations are resource intensive. Delete operations often require more processing power and I/O bandwidth than reads and writes. As a result of this demand on processing power and I/O bandwidth, delete operations can lead to delays in reads and writes. That is, when an application's concurrency level is high, and there are many delete operations in a storage controller's queue, the delete operations can end up squeezing out whatever other I/O may be in the queue.

Consequently, even though the high level of concurrency allows the entire workload to be processed faster than otherwise, read and write operations might be delayed while delete operations are processed. These delays result in increased response times for applications and can be problematic for client applications with specific performance expectations. In some cases, increased response times may lead to degraded performance or even application failures.

### SUMMARY

Disclosed herein are systems and methods that improve the concurrent processing of data storage operations. In an implementation, a storage controller identifies a storage operation to be processed and an available worker thread with which to process the storage operation. The storage operation may be associated with an application, for example, while the available worker thread corresponds to a core in a multicore processor that can be used to execute the storage operation. The storage controller proceeds to determine whether to use the available worker thread to execute the storage operation based on an application concurrency limit associated with the application and on an operation type concurrency limit associated with the operation type of the storage operation. In the affirmative case, the storage controller executes the operation on the thread.

This Summary introduces a selection of concepts in a simplified form that are further described below. It may be understood that this Summary is not intended to identify key features or essential features of the claimed subject matter, nor is it intended to be used to limit the scope of the claimed subject matter.

### BRIEF DESCRIPTIONS OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modification's, and equivalents.

FIG. 1 illustrates an operating environment in accordance with an implementation.

FIG. 2 illustrates a software architecture in accordance with an implementation.

FIG. 3 illustrates a method in accordance with an implementation.

FIG. 4 illustrates concurrency tables in accordance with an implementation.

FIG. 5 illustrates a further operating environment in accordance with an implementation.

FIG. 6 illustrates a further method in accordance with an implementation.

FIG. 7A illustrates an interface in accordance with an implementation.

FIG. 7B illustrates an interface in accordance with an implementation.

FIG. 7C illustrates an interface in accordance with an implementation.

FIG. 7D illustrates an interface in accordance with an implementation.

FIG. 8 illustrates a computing device used in accordance with several implementations.

### DETAILED DESCRIPTION

Technology is disclosed herein that relates to a storage controller designed to efficiently manage storage operations. The storage controller includes one or more computer-readable storage media and one or more processors that are operatively coupled with the storage media. The storage controller is equipped with program instructions that are stored on the storage media. When these instructions are read and executed by the processors, they enable the storage controller to perform the following tasks: identify storage operations associated with an application, allocate worker threads to execute the storage operation, and determine whether to allocate the available worker thread based on two concurrency limits, also referred to as concurrency settings.

The application concurrency limit indicates how many worker threads can be allocated to storage operations associated with the application, while the operation concurrency limit indicates how many worker threads can be allocated to a specific type of storage operation. If the storage controller determines that the available worker thread can be allocated to the storage operation, it executes the storage operation using the available worker thread.

Additionally, the storage controller includes features such as comparing the number of worker threads allocated to storage operations with the application concurrency limit, checking the operation concurrency limit, and skipping execution if the concurrency limits are met or exceeded. The program instructions also direct the processors to determine the operation concurrency limit or, in general, to apply operation concurrency policies based on a storage performance metric, such as operation latency, associated with the application. In some scenarios, the application concurrency levels for each application are set to the same level or value, meaning that the allocation of worker threads may happen with regard to operation type priority alone. In some cases, dynamic application of operation concurrency or dynamic determination of priority levels for storage operations are based on a metric such as processor utilization. For example, where the percentage of processor (or processing resources) utilization satisfies a threshold, operation concurrency policies can be applied or modified.

Various embodiments of the present technology provide for a wide range of technical effects, advantages, and/or improvements to computing systems and components. For example, various embodiments may include one or more of the following technical effects, advantages, and/or improvements: 1) non-routine and unconventional operations to allow for granular concurrency level application to I/O operations (e.g., selectively reduce concurrency of one type of I/O operation while allowing other operation types to maintain higher levels of concurrency); 2) non-routine and unconventional operations that allow for dynamic concurrency level setting for different operation types; 3) introduction of a new layer of concurrency control applied at the chunk service level above the file system; 4) non-routine and unconventional operations for thread allocation based on set concurrency levels; 5) unconventional system architecture and operations for operation specific concurrency configurations and thread allocation; 6) unconventional system architectures and operations for dynamically limiting resources for maintenance workflows (e.g., storage node decommissioning, background data movements based on ILM configurations, balancing of storage utilization among nodes, etc.); 7) non-routine and unconventional operations for thread allocation based on a background or foreground type of a given operation; 8) non-routine and unconventional application of operation type concurrency, allowing for improved processing of workloads for multithreaded programs using multicore processors; and/or 9) non-routine and unconventional use of dynamic applications of operation type concurrency, allowing for efficient allocation of storage controller resources data storage system processes and more efficient use of data storage resources.

For example, by dynamically applying or adjusting the concurrency levels for different types of storage operations, the storage controller ensures that resources are allocated efficiently, preventing any single type of operation from monopolizing resources and allowing for balanced performance across all operations. This results in improved performance, as the storage controller can maintain high performance for critical operations like reads and writes, even when there is a high volume of delete operations. This leads to faster response times and better overall system performance. Additionally, the ability to adjust concurrency based on storage performance metrics, such as operation latency or processor utilization, helps minimize delays, ensuring that client applications experience lower latency and improved responsiveness.

The technology is also scalable and capable of handling increasing workloads by dynamically adjusting concurrency levels, making it suitable for environments with varying demands and large volumes of data. By preventing any single type of operation from overwhelming the system, the storage controller enhances the reliability and stability of the storage system, reducing the risk of failures and ensuring consistent performance. This efficient management of high volumes of delete operations, which are common in software-defined object storage solutions environments, addresses a key pain point for customers, leading to improved customer satisfaction and a better user experience.

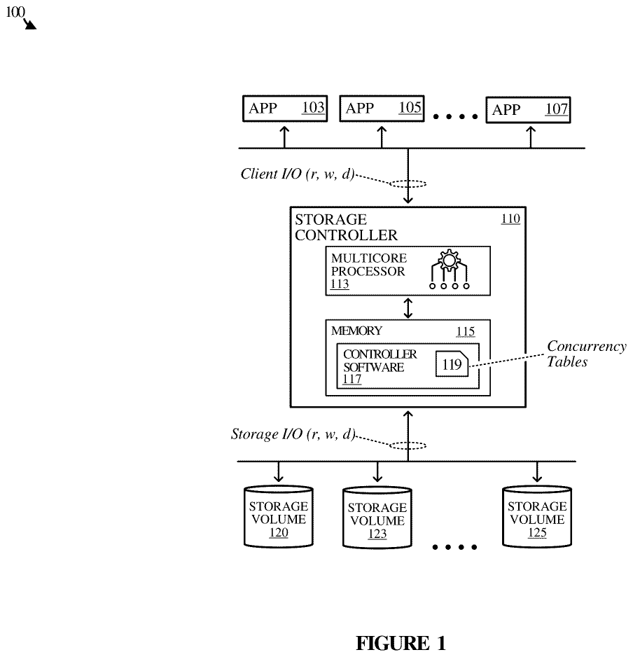

FIG. 1 illustrates operating environment 100 in accordance with an implementation. Operating environment 100 includes application 103, application 105, application 107, storage controller 110, storage volume 120, storage volume 123, and storage volume 125. Storage controller 110 includes processor 113 and memory 115. Memory 115 further includes controller software 117, which further includes concurrency tables 119.

Storage controller 110 is generally representative of a physical and/or virtual computing device configured to perform storage operations, such as a computer server or the like. Storage controller 110 includes one or more multicore processors (represented by processor 113) and memory 115. Processor 113 is representative of a multicore central processing unit capable of executing multithreaded software applications. Memory 115 is representative of one or more data storage devices such as random-access memory (RAM), persistent storage, or other such computer readable storage media, on which software may be stored and from which software may be loaded to and executed by processor 113.

Storage controller 110 further includes controller software 117 stored on memory 115. Controller software 117 is representative of software and/or firmware that, when executed by processor 113, allows storage controller 110 to manage the storage of data on storage volumes 120, 123, and 125. For example, storage controller 110 executes controller software 117 to manage read, write, and delete requests communicated by applications 103, 105, and 107.

Application 103, application 105, and application 107 are each representative of applications that generate client input and output (I/O) operation requests. In operation, application 103, application 105, and application 107 are each configured to produce client I/O requests and submit the client I/O requests to storage controller 110 for processing. For example, in some scenarios, each of application 103, application 105, and application 107 produce read, write, or delete operation requests and submit the read, write, or delete operation requests to storage controller 110. In such an example, the operation requests correspond to a data object stored in storage volume 120, storage volume 123, storage volume 125, or a combination thereof.

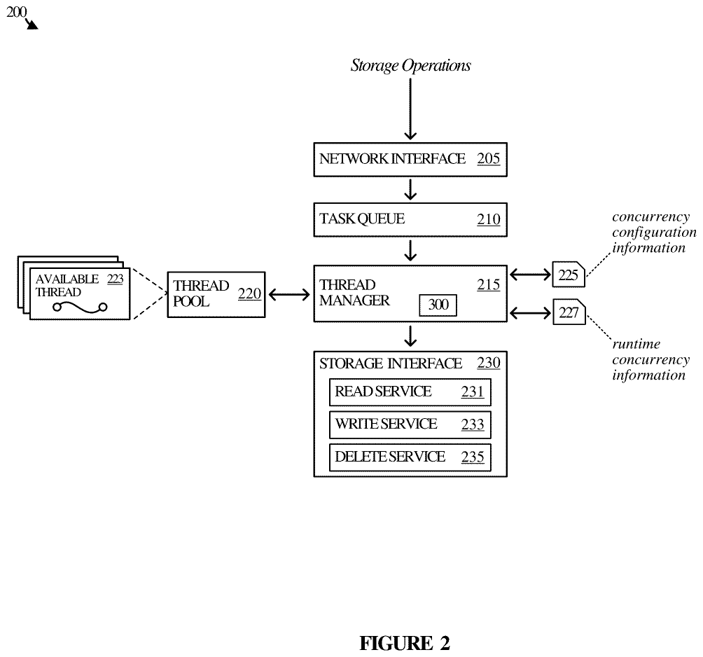

FIG. 2 illustrates software architecture 200 in accordance with an implementation. Software architecture 200 is representative of a software architecture for implementing controller software 117 in FIG. 1. Software architecture 200 includes network interface 205, task queue 210, thread manager 215, thread pool 220, concurrency table 225, concurrency table 227, and storage interface 230. Thread manager 215 further includes method 300. Thread pool 220 further includes available worker thread 223. Storage interface 230 further includes read service 231, write service 233, and delete service 235. In some scenarios, software architecture 200 may include fewer elements or may include elements that are not shown in FIG. 2 for clarity.

Network interface 205 is a software layer that facilitates data exchange between storage controller 110 and applications 103, 105, and 107. Storage interface 230 is a layer that facilitates the reading and writing of data to and from storage volumes in response to storage operation requests initiated by any of applications 103, 105, and 107. Storage interface 230 includes read service 231, write service 233, and delete service 235. Read service 231 is representative of one or more software components capable of reading data from storage; write service 233 is representative of one or more software components capable of writing data to storage; and delete service 235 is representative of one or more components capable of deleting data from storage.

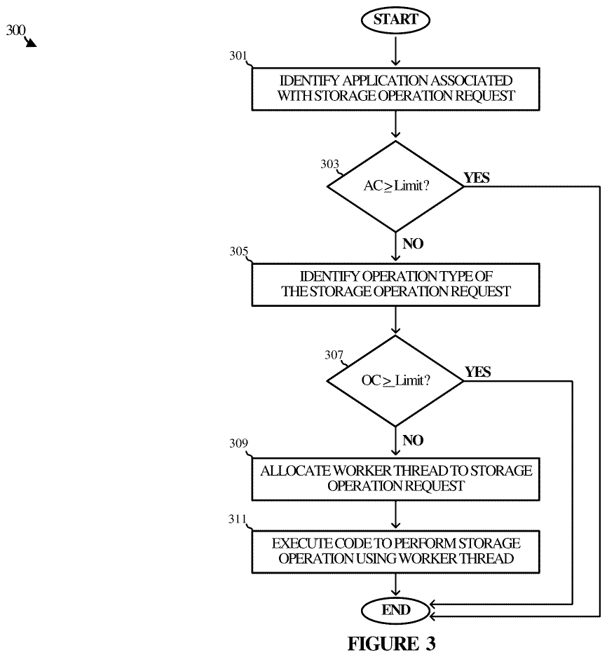

Thread manager 215 is representative of one or more software components that manage the allocation of threads from thread pool 220 to the storage services provided by storage interface 230. Thread manager 215 employs method 300, described below with respect to FIG. 3, when allocating an available thread (e.g., available worker thread 223) to a storage service. Thread pool 220 is generally representative of a collection of pre-initialized worker threads (e.g., that can execute tasks concurrently. Instead of creating a new thread for each task, an available worker threads (e.g., available worker thread 223) from thread pool 2250 are used to execute the tasks.

Referring to FIG. 3, method 300 may be implemented in program instructions in the context of the software and/or firmware elements of storage controller 110 of FIG. 1, such as thread manager 215. The program instructions, when executed by one or more processing devices of storage controller 110 direct the one or more computing systems to operate as follows, referring parenthetically to the steps in FIG. 3.

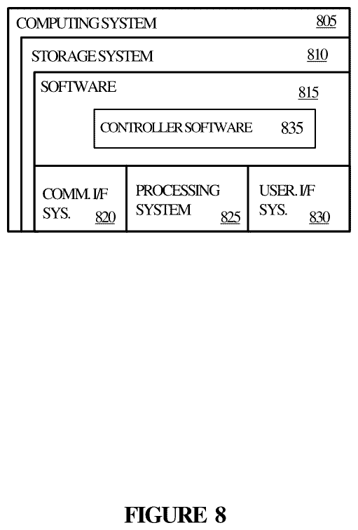

FIG. 3 illustrates method 300 in accordance with an implementation. Method 300 may be implemented in program instructions in the context of the software and/or firmware elements of storage controller 110 of FIG. 1, thread manager 215 of FIG. 2, or a combination thereof. The program instructions, when executed by one or more processing devices of one or more computing systems (e.g., computing device 805 in FIG. 8), direct the one or more computing systems to operate as follows, referring parenthetically to the steps in FIG. 3, and in the singular to a computing device for the sake of clarity.

To begin, a storage controller of a data storage system (e.g., storage controller 110 of FIG. 1) identifies an application (e.g., application 103 of FIG. 1) associated with a storage operation request (step 301). In some embodiments, the identity of the application is used to govern how storage operations associated with that application are treated. In some embodiments, storage operations associated with various applications are organized into task queues based on the identity of the associated applications (e.g., task queue 210 of FIG. 2). In such embodiments, the task queues may have a specified priority that specifies how worker threads are to process storage operations from the task queues.

For example, there may be a critical task queue, a default task queue, and a background task queue. The critical task queue can be reserved for critical processes that an administrator wishes to prioritize, such as client read operations. The default task queue can be used for a variety of processes of varying importance. The background queue can be used for background processes (e.g., load balancing processes) and other lower priority processes of the data storage system. An administrator can configure each of the task queues to utilize up to a given maximum number of worker threads in a data storage system. Tasks (e.g., I/O operations) are loaded into each of the queues based on a priority associated with the request. For instance, a certain application may be highly important. As a result, I/O operations that originate at that application are loaded into the critical queue. In an example, the critical task queue may be permitted to use any number of worker threads and can therefore utilize any available worker thread at any time. The default task queue may be limited to no more than three-quarters of the available worker threads. A task in the default task queue is executed with an available worker thread only where assigning that worker thread to the task does not offend the configured concurrency limit (three-quarters of the available threads). The background task queue may be limited to no more than one-quarter of the available worker threads. A task in the background task queue is executed with an available worker thread only where assigning that worker thread to the task does not offend the configured concurrency limit (one-quarter of the available threads).

In some embodiments, worker threads are configured to first check the critical task queue, and where a storage operation is available for processing in the critical task queue, to process the operation. In some embodiments, where a storage operation is not available in the critical task queue, a worker may then check the default queue or the background queue. In some embodiments, the various priority levels of the task queues may correspond to a proportion of the overall available worker threads or to a proportion of the overall computing resources available. For example, a given task queue may be limited to ten of twenty total worker threads of a data storage system. In such an example, where another task queue is limited to five of the twenty total worker threads of a data storage system, the first task queue has a higher priority level than the second by virtue of the proportion of the total worker threads the tasks in the queue may simultaneously utilize. In some cases, the priority of each of the task queues is set to a similar value so that, in effect, all applications share the same priority. For example, two different task queues may both be permitted to utilize ten of twenty total worker threads of a data storage system. Here, both task queues are configured with the same priority. In such an example, operation type priority specific to an application associated with the first task queue may differ from an operation type priority specific to an application associated with the second task queue. While the applications may have similar priority by virtue of the task queues they are associated with, operations from the two applications can be handled differently and with different numbers of worker threads based on the operation type priorities of the two applications.

Beneficially, the multiple levels of configurable concurrency (e.g., application concurrency and operation concurrency) allow specific types of storage operations (e.g., delete operations) generated by certain applications to be independently prioritized among other specific storage operations from other applications. For example, where a certain application produces such a high volume of deletes that computing resources are disproportionately consumed by those deletes, the priority for delete operations from that particular application can be limited. As a result, the deletes are blocked from consuming a disproportionate amount of computing resources, while other operations from that same application (e.g., read operations from that application) can still be prioritized with respect to storage operations from other applications.

In some embodiments, identifying the application is based on metadata for the storage operation request. The storage controller then determines whether to allocate an available worker thread to the storage operation request based on an application concurrency limit and an operation type concurrency limit. To establish these limits, an administrator can configure restrictions that limit the number of worker threads that can execute tasks associated with a given application, tasks of a given operation type, or a combination thereof. In some cases, the administrator may modify these priority levels based on operational characteristics of the data storage system. For example, a particular application may begin producing a substantial number of deletes that bog down the processing resources of the data storage system. In response, an administrator can limit the number of worker threads permitted to execute operations for that particular application. In another example, a particular application may begin producing a substantial number of deletes that bog down processing resources of the data storage system but also produce critical operations that must be executed as efficiently as possible. In such an example, an administrator may opt not to limit the concurrency of operations of the application entirely, but instead to limit the concurrency of merely the delete operations associated with that application. In some embodiments, the storage controller identifies the available worker thread by interacting with a thread pool (e.g., thread pool 220 of FIG. 2).

In some scenarios, an administrator may try different combinations of priority and concurrency configurations for a data storage system to optimize the use of resources in the system. In such scenarios, the administrator may analyze response latencies for certain operations or other performance metrics to determine if data storage system resources are being disproportionately consumed by other processes or applications of the system. For instance, where the response latency is greater than expected, an administrator may decrease the priority and concurrency of certain applications and processes of the data storage system in order to reduce the disproportionate consumption of system resources.

If the application concurrency for the application is greater than the application concurrency limit, the available worker thread is not allocated to the storage operation request (303). In some scenarios, an application or operation type concurrency limit may be reconfigured during the operation of the data storage system. In such scenarios, the number of worker threads allocated to operations of a particular application may exceed the newly configured limit as a result of the higher previous limit. In some embodiments, should the number of worker threads allocated to storage operations for the application meet or exceed the limit on the number of worker threads that can be allocated to operations for the application (i.e., the application concurrency limit), the available worker thread is not allocated to the storage operation request. The storage operation request is, therefore, not executed by that worker thread at that time.

In some embodiments, the storage operation request was first loaded into a particular priority queue before the storage controller determined not to allocate the available worker thread to the request. In such embodiments, the request remains in the queue until an available worker thread can be assigned to the request without meeting or exceeding the application concurrency limit.

In some embodiments, the storage controller determines the current application concurrency for the application by determining the number of worker threads already allocated to storage operations associated with the application. In such embodiments, the storage controller compares the number of worker threads already allocated for the application with the application concurrency limit for the application. In some embodiments, the storage controller reads application concurrency configuration information from a table (e.g., concurrency table 225 of FIG. 2) to identify the application concurrency limit for the application. In some embodiments, the storage controller reads runtime concurrency information from a table (e.g., concurrency table 227 of FIG. 2) to determine the number of worker threads already allocated to storage operations associated with the application.

If the application concurrency for the application is below the application concurrency limit, the storage controller identifies an operation type of the storage operation request (step 305). In some embodiments, the operation type of the storage operation request is identified via metadata associated with the storage operation request, while in other embodiments, the operation type of the storage operation request is identified through an analysis of the storage operation request itself. With the operation type identified, the storage controller then performs an operation type concurrency evaluation for the storage operation request.

If the operation type concurrency for the operation type of the storage operation request is greater than the operation type concurrency limit, the available worker thread is not allocated to the storage operation request (307). In some embodiments, the operation type may be a delete type operation, a write type operation, a read type operation, or any other type of storage operation. In some embodiments, the storage controller determines the number of worker threads already allocated to storage operations of the operation type that are associated with the application and compares the number with an operation type concurrency limit for the operation type and the application. In some embodiments, the storage controller reads operation type concurrency configuration information from a table (e.g., concurrency table 225) to facilitate the evaluation. In some embodiments, the storage controller reads runtime concurrency information from a table (e.g., concurrency table 227) to determine the number of worker threads already allocated to storage operations of the operation type associated with the application.

If the operation type concurrency for the operation type of the storage operation request is below the operation type concurrency limit, the available worker thread is allocated to the storage operation request (step 309). Code (i.e., executable instructions) for performing the storage operation is then executed using the available worker thread (step 311). In some embodiments, the code for performing the storage operation is a service of a storage interface (e.g., read service 231 of FIG. 2, write service 233 of FIG. 2, and delete service 235 of FIG. 2).

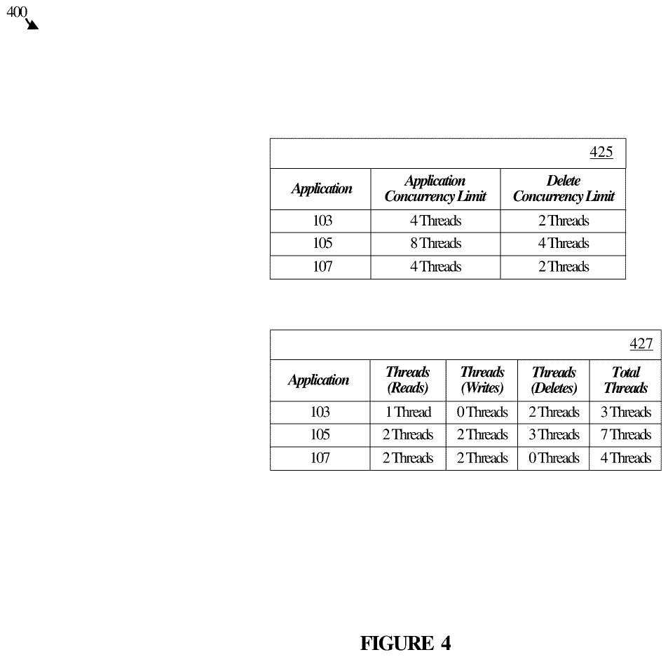

FIG. 4 illustrates operational scenario 400 in accordance with an implementation. Operational scenario 400 includes concurrency table 425 and concurrency table 427. Each of concurrency table 425 and concurrency table 427 include concurrency information for application 103, application 105, and application 107, each of FIG. 1, respectively.

Concurrency table 425 is populated with application concurrency limits and operation type concurrency limits for each of application 103, application 105, and application 107. Application 103 has an application concurrency limit of four threads and an operation type concurrency limit of two threads for delete operations. Application 105 has an application concurrency limit of eight threads and an operation type concurrency limit of four threads for delete operations. Application 107 has an application concurrency limit of four threads and an operation type concurrency limit of two threads for delete operations.

Concurrency table 427 is populated with runtime concurrency information for each of application 103, application 105, and application 107 to support application concurrency evaluations and operation type concurrency evaluations. For each application, the total number of threads and the number of threads allocated for read operations, write operations and delete operations are tracked. Where a thread manager (e.g., thread manager 215 of FIG. 2) allocates an available worker thread (e.g., available worker thread 223 of FIG. 2) to a storage operation having a given operation type for a given application, the corresponding values in concurrency table 427 are incremented. When the worker thread completes the execution of the storage operation and is returned to a thread pool (e.g., thread pool 220 of FIG. 2), the corresponding values in concurrency table 427 are decremented such that the runtime concurrency information of concurrency table 427 is kept up to date.

In the scenario illustrated by operational scenario 400, concurrency table 427 shows that application 103 is currently allocated a single thread for read operations, zero threads for write operations, and two threads for delete operations, totaling three threads overall. Application 105 is currently allocated two threads for read operations, two threads for write operations, and three threads for delete operations, totaling seven threads overall. Finally, application 107 is currently allocated two threads for read operations, two threads for write operations, and zero threads for delete operations, totaling four cores overall.

In this example, the total number of threads allocated to application 107 meets the relevant application concurrency limit given in concurrency table 425. As a result, no further worker threads are allocated to storage operations associated with application 107. In contrast, the total number of threads allocated to both application 103 and application 105 do not meet or exceed the relevant application concurrency limits given in concurrency table 425. As a result, additional worker threads may be allocated to storage operations associated with application 103 and application 105.

However, application 103 is currently allocated two threads for delete operations, which meets the delete concurrency limit given for application 103 in concurrency table 425. As a result, while an additional worker thread can be allocated to a storage operation associated with application 103, the storage operation cannot be of a delete operation type. Alternatively, the worker threads allocated to delete operations associated with application 107 do not meet or exceed the delete concurrency limit given in concurrency table 425. As a result, an additional worker thread can not only be allocated to a storage operation associated with application 103, but the storage operation can be of any operation type.

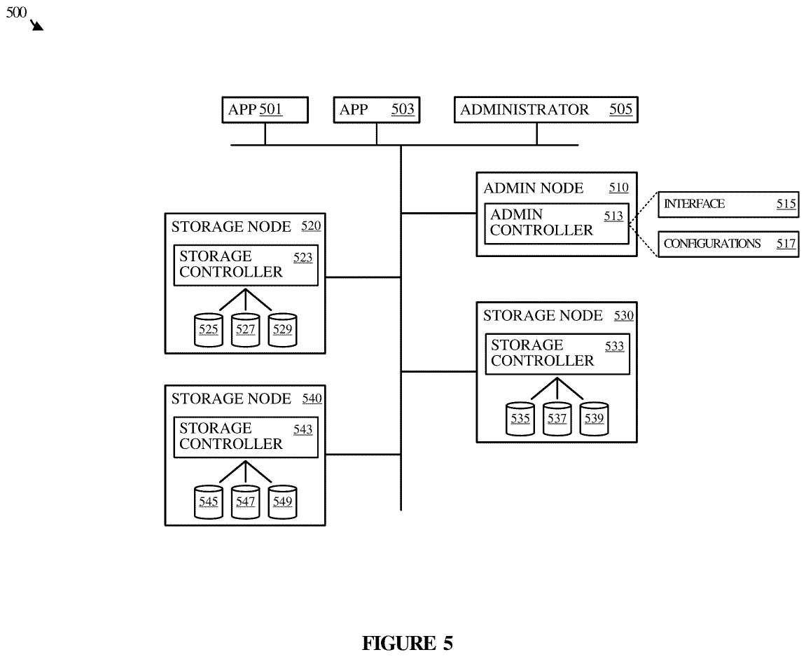

FIG. 5 illustrates further operating environment 500 in accordance with an implementation, hereinafter referred to as environment 500. Environment 500 includes application 501, application 503, administrator 505, admin node 510, storage node 520, storage node 530, and storage node 540. Admin node 510 further includes admin controller 513, which further includes interface 515 and configurations 517. Storage node 520 further includes storage controller 523, storage volume 525, storage volume 527, and storage volume 529. Storage node 530 further includes storage controller 533, storage volume 535, storage volume 537, and storage volume 539. Storage node 540 further includes storage controller 543, storage volume 545, storage volume 547, and storage volume 549.

Environment 500 is representative of a further environment in which client applications and storage system processes generate storage operation requests to be processed by the storage system. As a whole, admin node 510, storage node 520, storage node 530, and storage node 540 may be considered as a cluster storage system (i.e., a distributed storage architecture combining multiple storage devices into a unified system).

Application 501 and application 503 are each substantively the same as application 103 of FIG. 1 and application 105 of FIG. 1, respectively. Administrator 505 is generally representative of a user who has the authority to configure various elements of the environment 500. In particular, administrator 505 is any actor or process capable of configuring application concurrency limits and operation type concurrency limits for a data storage system. In some embodiments, administrator 505 interacts with interface 515 to configure an application concurrency limit and an operation type concurrency limit for a data storage system. In some embodiments, interface 515 includes interactable elements for configuring the application concurrency limit and operation type concurrency limit, such as a value slider, a drop-down menu, or any other interactable element sufficient to allow administrator 505 to communicate concurrency configuration information. In some cases, where administrator 505 interacts with interface 515 to configure application concurrency limits and operation type concurrency limits, the concurrency information is stored in configurations 517. The concurrency information contained in configurations 517 can then be distributed to each of storage node 520, storage node 530, and storage node 540 to govern the subsequent execution of storage operations.

Each of admin node 510, storage node 520, storage node 530, and storage node 540 are generally representative of nodes in a cluster storage system (i.e., individual computing units that contribute processing power, storage capacity, and network connectivity to support operations across a cluster storage system. Admin node 510 is responsible for the administration and management of the cluster storage system and, in particular, allows administrator 505 to configure various settings and parameters of the cluster storage system. Admin node 510 includes admin controller 513, which includes interface 515 and configurations 517. Each of storage node 520, storage node 530, and storage node 540 include similar constituent elements and facilitate data storage operations throughout the cluster storage system.

Each of storage volume 525, storage volume 527, storage volume 529, storage volume 535, storage volume 537, storage volume 539, storage volume 545, storage volume 547, and storage volume 549 are generally representative of nonvolatile data storage resources and are each substantively the same as storage volume 120 of FIG. 1, storage volume 123 of FIG. 1, and storage volume 125 of FIG. 1, respectively.

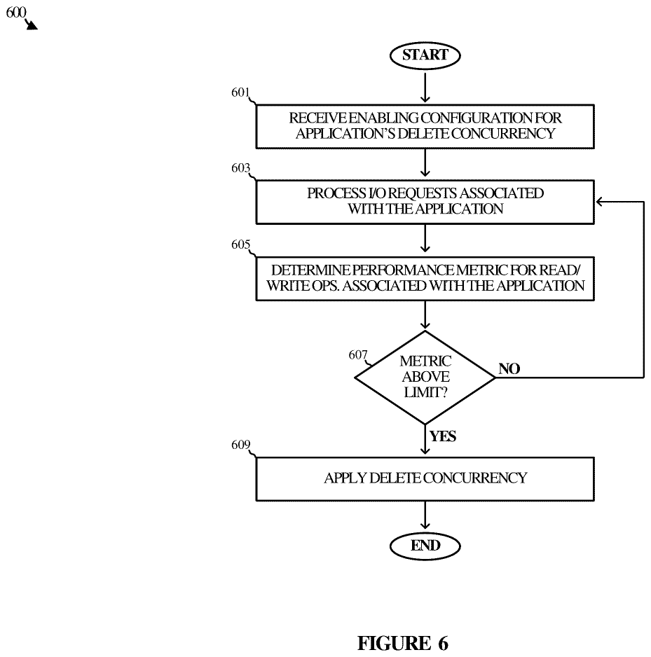

FIG. 6 illustrates further method 600 in accordance with an implementation. Further method 600 may be implemented in program instructions in the context of the software and/or firmware elements of admin controller 513 of FIG. 5, storage controller 523 of FIG. 5, storage controller 533 of FIG. 5, storage controller 543 of FIG. 5, or a combination thereof. The program instructions, when executed by one or more processing devices of one or more computing systems (e.g., computing device 805 in FIG. 8), direct the one or more computing systems to operate as follows, referring parenthetically to the steps in FIG. 3, and in the singular to a computing device for the sake of clarity.

Further method 600 is representative of an alternative technique for applying operation type concurrency, and in particular, delete concurrency. Here, an administrator enables delete concurrency, but the storage controller does not apply delete concurrency until a performance metric exceeds a threshold.

To begin, an administrative controller of a data storage system (e.g., admin controller 513) receives an enabling configuration for the delete concurrency of an application (e.g., application 501 of FIG. 5, application 503 of FIG. 5) (step 601). The administrative controller distributes the configuration information for the delete concurrency of the application to each storage node (e.g., storage node 520, storage node 530, storage node 540) of the data storage system.

A storage controller of a storage node (e.g., storage controller 523, storage controller 533, storage controller 543) of the system begins processing I/O requests associated with the application (step 603). The I/O requests may be received directly at a storage node or may also be received at an administrative node before being routed to a storage node.

The storage controller processing the I/O requests determines a performance metric for the execution of read operations and write operations being processed by the storage controller (step 605). In some cases, the performance metric associated with the read operations and write operations may be a processor utilization metric. In some cases, the performance metric may be a response latency associated with the read operations and write operations. For example, a latency metric may be a measure of the time period between a storage controller receiving an I/O request and the execution of that I/O request. In some embodiments, the latency metric is a measure of the latency for read operations and write operations.

At this point, though operation type concurrency has been enabled, operation type concurrency is not yet being applied. The storage controller then determines if the performance metric exceeds a predetermined latency threshold (step 607). In some scenarios, the threshold is a predetermined value configured by an administrator, while in other scenarios, the threshold may be a default value. Where the performance metric does not exceed, or in some cases meet, the predetermined latency threshold, the storage controller continues processing I/O requests associated with the application.

Where the performance metric exceeds, or in some cases meets, the predetermined latency threshold, the storage controller applies operation type concurrency in order to improve the performance metric for the data storage system (step 609). In embodiments, where the performance metric refers to the latency of read operations and write operations, the operation type concurrency is specific to delete concurrency.

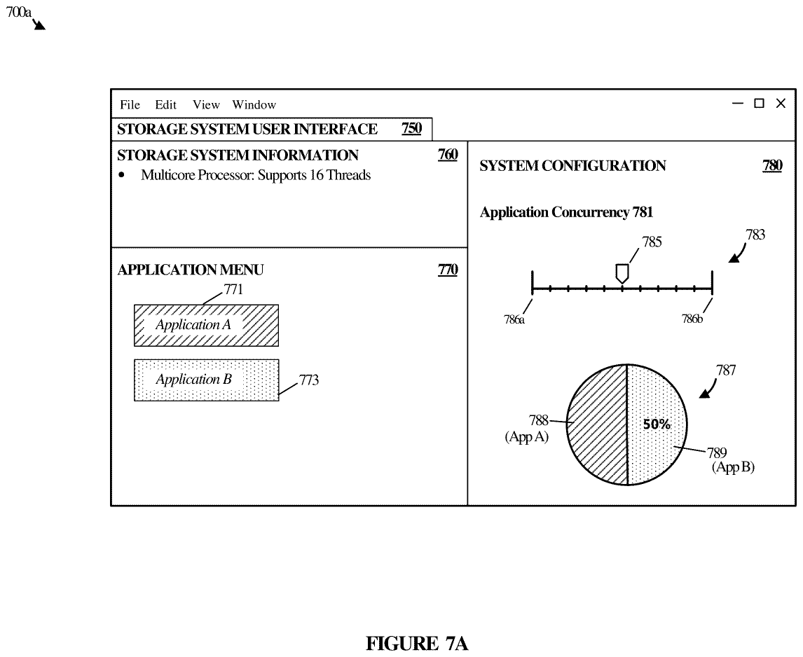

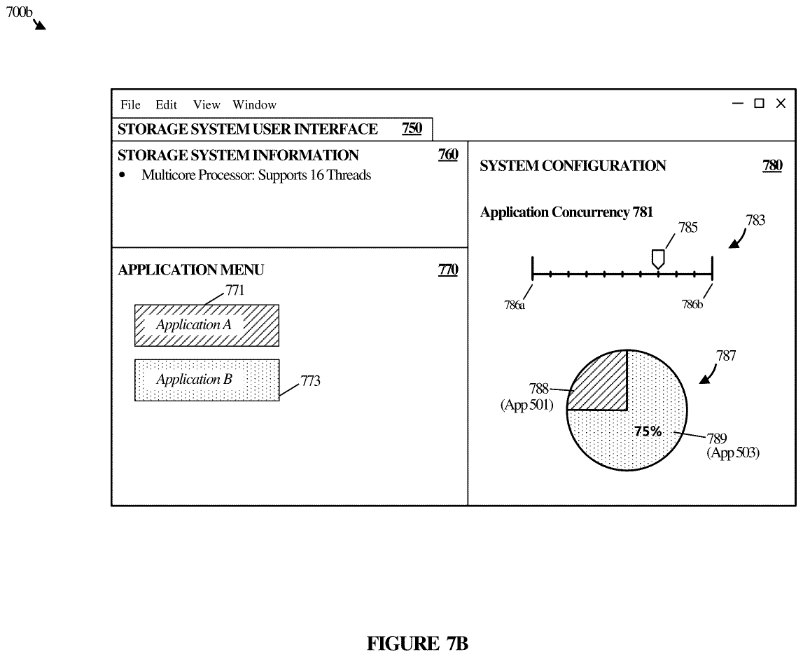

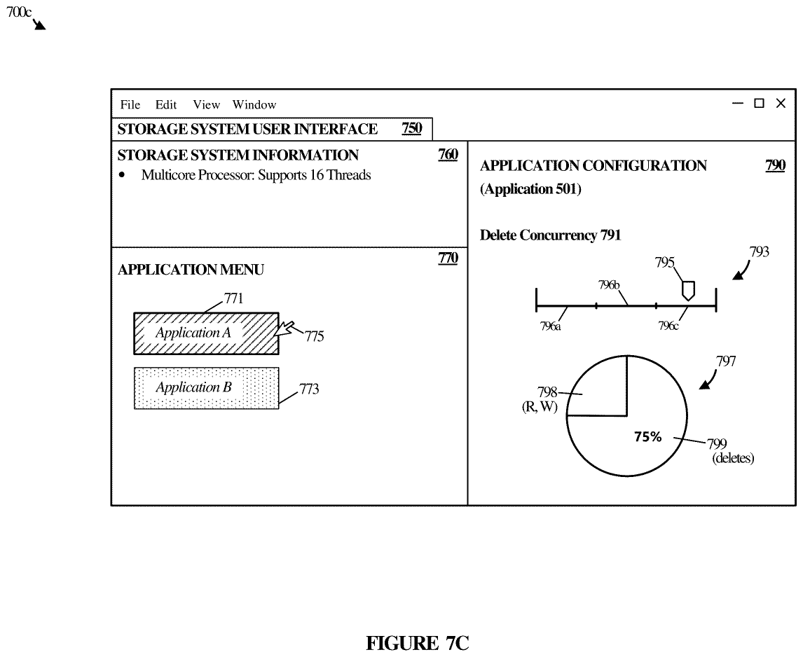

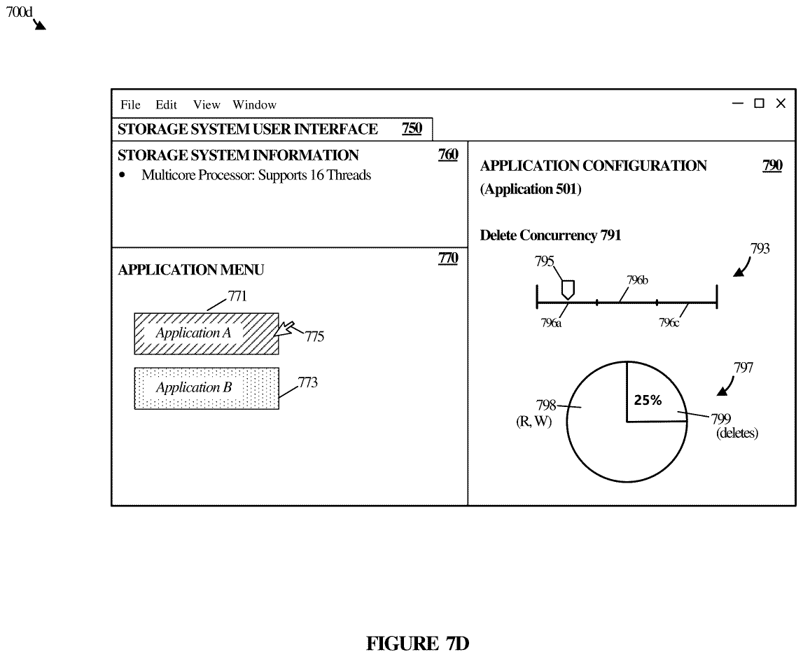

FIG. 7A illustrates interface 700a in accordance with an implementation. Interface 700a includes interface name 750, information 760, application menu 770, and system configuration 780. Application menu 770 further includes button 771 and button 773. System configuration 780 further includes application concurrency slider 783, indicator 785, leftmost position 786a, rightmost position 786b, chart 787, portion 788, and portion 789. Interface 700a may be considered in the context of FIG. 5, and in particular, may be considered as a detailed example of interface 515.

Interface 700a is generally representative of a storage system user interface. Interface 700a may facilitate any number of processes in a data storage system, such as data storage operations, system configurations, and any other processes relevant to the operation of a data storage system. Interface name 750 is labeled “Storage System User Interface,” indicating that the current interface shown in FIG. 7A can be used with respect to the storage system shown in FIG. 5.

Information 760 is representative of an interface element for displaying different information relevant to the overall storage system that interface 700a is associated with. As shown in FIG. 7A, information 760 indicates that a multicore processor (e.g., processor 113) utilized in the storage system supports sixteen threads of execution, meaning that sixteen threads can be simultaneously processed by the multicore processor.

Application menu 770a is representative of an interface element for displaying current configurations for various applications and operations of the data storage system. In particular, Application menu 770 displays button 771 and button 773, which are interactable elements that correspond to application A and application B, respectively. Application A and application B are generally representative of applications, examples of which are given by application 501 of FIG. 5 and application 503 of FIG. 5. Button 771 and button 773 can be selected in order to configure the corresponding application via interface 700a. In some embodiments, application menu 770a may include more or fewer applications. Interface 700a illustrates that neither button 771 nor button 773 have been selected, and as a result, interface 700a defaults to displaying system configuration 780. Where button 771 and button 773 are selected, interface 700a modifies the visible display based on the selection.

System configuration 780 is representative of an interactable interface element for setting the configurations associated with a data storage system. System configuration 780 allows an administrator to configure the system settings for the data storage system and, in particular, to configure the application concurrency for each application interacting with the data storage system. In the illustrated embodiment, an administrator may change the position of indicator 785 on application concurrency slider 783 in order to establish different application concurrencies. Leftmost position 786a on application concurrency slider 783 corresponds to allowing application A to consume the highest proportion of processing resources, while rightmost position 786b on application concurrency slider 783 corresponds to allowing application B to consume the highest proportion of processing resources. As shown in system configuration 780, indicator 785 is in the middle of application concurrency slider 783, and as a result, chart 787 shows that application A may consume fifty percent of the processing resources, and that application B may consume fifty percent of the processing resources. Portion 788 of chart 787 corresponds to the proportion of processing resources application A is permitted to consume, while portion 789 of chart 787 corresponds to the proportion of processing resources application B is permitted to consume.

FIG. 7B illustrates interface 700b in accordance with an implementation. Interface 800c is substantively the same as interface 700a, except that indicator 785 is now located in a different position on application concurrency slider 783. As shown in FIG. 7B, indicator 785 is now closer to rightmost position 786b on application concurrency slider 783, meaning that a larger proportion of processing resources can be allocated to application B in comparison to application A.

FIG. 7C illustrates interface 700c in accordance with an implementation. Interface 700c includes interface name 750, information 760, application menu 770b, and application configuration 790. Application menu 770 further includes cursor 775, button 771, and button 773. Application configuration 790 further includes delete concurrency slider 793, indicator 795, region 796a, region 796b, region 796c, chart 797, portion 789, and portion 799. Interface 700c may be considered in the context of FIG. 5, and in particular, may be considered as a detailed example of interface 515.

As shown in FIG. 7C, cursor 775 is hovering over button 771, indicating that button 771 has been selected. Button 771 corresponds to application A, meaning that the selection of button 771 results in the selection of application A. In response to the selection of application A from application menu 770, the visual elements seen in interface 700c are modified, and configurable elements specific to application A are displayed. In particular, interface 700c displays interactable elements for configuring delete concurrency for application A.

Delete concurrency slider 793 is representative of an interactable element of interface 700c for configuring a delete concurrency. As illustrated in interface 700c, delete concurrency slider 793 has three distinct regions, region 796a, region 796b, and region 796c, that correspond to distinct concurrency values and in each of which indicator 795 may be positioned. Region 796a, region 796b, and region 796c correspond to low delete concurrency, moderate delete concurrency, and high delete concurrency, respectively. For example, positioning indicator 795 in region 796a (a low delete concurrency slider position) may result in a delete concurrency limit of just one thread for application A, while positioning indicator 795 in region 796c (a high delete concurrency slider position) may result in a delete concurrency limit of fourteen of sixteen total cores for the application A. In some cases, the slider positions of delete concurrency slider 793 are translated to explicit concurrency values based on a static algorithm. In some cases, the slider positions of delete concurrency slider 793 are dynamically translated to explicit concurrency values by an algorithm based on the slider position and other storage system performance metrics, such as the latency between the enqueueing of a storage operation request and execution of the storage operation request.

Currently, interface 700c shows that indicator 785 is set to the high concurrency region of delete concurrency slider 793. As shown in chart 797, delete operations associated with application 501 are permitted to consume seventy-five percent of the processing resources of the multicore processor, thereby leaving twenty-five percent of the computing resources reserved for read operations and write operations associated with application 501. This distribution of processing resources for various operations of application A is illustrated through portion 798 and portion 799 of chart 797. Portion 798 corresponds to read operations and write operations, while portion 799 corresponds to delete operations.

FIG. 7D illustrates interface 700d in accordance with an implementation. Interface 700d includes interface name 750, information 760, application menu 770b, and application configuration 790. Application menu 770 further includes cursor 775, button 771, and button 773. Application configuration 790 further includes delete concurrency slider 793, indicator 795, region 796a, region 796b, region 796c, chart 797, portion 789, and portion 799. Interface 700d may be considered in the context of FIG. 5, and in particular, may be considered as a detailed example of interface 515.

Interface 700d and interface 700c are substantively similar except that, within application configuration 790 of interface 700d, indicator 795 is now set to region 796a (a low concurrency region of delete concurrency slider 793) in contrast to the position of indicator 795 in FIG. 7C. Here, delete concurrency for application A has been configured to have low concurrency. The resulting distribution of processing resources is illustrated by portion 798 and portion 799 of chart 797. As shown in chart 797, delete operations associated with application A are now permitted to consume only twenty-five percent of the processing resources of the multicore processor, thereby leaving seventy-five percent of the computing resources reserved for read operations and write operations associated with application A.

FIG. 8 illustrates computing device 805, which is representative of any system or collection of systems in which the various applications, processes, services, and scenarios disclosed herein may be implemented. Examples of computing apparatus illustrated by computing device 805 include, but are not limited to server computers, web servers, cloud computing platforms, and data center equipment, as well as any other type of physical or virtual server machine, container, and any variation or combination thereof. (In some examples, computing device 805 may also be representative of desktop and laptop computers, tablet computers, and the like.)

Computing device 805 may be implemented as a single apparatus, system, or device or may be implemented in a distributed manner as multiple apparatuses, systems, or devices. Computing device 805 includes but is not limited to, processing system 825, storage system 810, software 815, communication interface system 820, and user interface system 830. Processing system 825 is operatively coupled with storage system 810, communication interface system 820, and user interface system 830.

Processing system 825 loads and executes software 815 from storage system 810. Software 815 includes and implements controller software 835, which is representative of the processes discussed with respect to the preceding Figures. When executed by processing system 825, software 815 directs processing system 825 to operate as described herein for at least the various processes, operational scenarios, and sequences discussed in the foregoing implementations. Computing device 805 may optionally include additional devices, features, or functionality not discussed for purposes of brevity.

Referring still to FIG. 8, processing system 825 may include a micro-processor and other circuitry that retrieves and executes software 815 from storage system 810. Processing system 825 may be implemented within a single processing device but may also be distributed across multiple processing devices or sub-systems that cooperate in executing program instructions. Examples of processing system 825 include general purpose central processing units, microcontroller units, graphical processing units, application specific processors, integrated circuits, application specific integrated circuits, and logic devices, as well as any other type of processing device, combinations, or variations thereof.

Storage system 810 may comprise any computer readable storage media readable by processing system 825 and capable of storing software 815. Storage system 810 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 810 may be implemented as a single storage device but may also be implemented across multiple storage devices or sub-systems co-located or distributed relative to each other. Storage system 810 may comprise additional elements, such as a controller, capable of communicating with processing system 825 or possibly other systems.

Software 815 (including controller software 835) may be implemented in program instructions and, among other functions, may, when executed by processing system 825, direct processing system 825 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multithreaded, or in accordance with any other suitable execution paradigm, variation, or a combination thereof. Software 815 may include additional processes, programs, or components, such as operating system software, virtualization software, or other application software. Software 815 may also be comprised of firmware or some other form of machine-readable processing instructions executable by processing system 825.

In general, software 815, when loaded into processing system 825 and executed, transforms a suitable apparatus, system, or device (of which computing device 805 is representative) overall from a general-purpose computing system into a special-purpose computing system customized to support storage processes as described herein. Indeed, encoding software 815 on storage system 810 may transform the physical structure of storage system 810. The specific transformation of the physical structure may depend on various factors in different implementations of this description. Examples of such factors may include, but are not limited to, the technology used to implement the storage media of storage system 810 and whether the computer-storage media are characterized as primary or secondary storage, as well as other factors.

For example, if the computer readable storage media are implemented as semiconductor-based memory, software 815 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 820 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 805 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when read and executed by the one or more processors, direct the computing apparatus to at least:
identify a storage operation associated with an application,
determine whether to allocate an available worker thread to the storage operation based on an application concurrency limit associated with the application and operation concurrency limit associated with a type of the storage operation; and
in response to determining to allocate the available worker thread to the storage operation, execute the storage operation using the available worker thread.

2. The computing apparatus of claim 1, wherein the application concurrency limit indicates how many worker threads can be allocated to storage operations associated with the application.

3. The computing apparatus of claim 2, wherein the operation concurrency limit indicates how many worker threads allocated to storage operations associated with the application can be allocated to a specific storage operation type.

4. The computing apparatus of claim 3, wherein to determine whether to allocate the available worker thread to the storage operation based on the application concurrency limit associated with the application, the program instructions direct the one or more processors to compare a number of worker threads allocated to storage operations associated with the application to the application concurrency limit associated with the application.

5. The computing apparatus of claim 4, wherein to determine whether to allocate the available worker thread to the storage operation based on the operation concurrency limit associated with the type of the storage operation, a storage controller is configured to compare a number of worker threads allocated to storage operations of the type to the operation concurrency limit.

6. The computing apparatus of claim 5, further comprising:
determining that the number of worker threads allocated to the storage operations associated with the application does not meet or exceed the application concurrency limit associated with the application; and
responsively evaluating the operation concurrency limit for the storage operation.

7. The computing apparatus of claim 6, wherein the storage controller is further configured to:
determine, in response to determining that the number of worker threads allocated to the storage operations associated with the application do not meet or exceed the application concurrency limit associated with the application, that the number of worker threads allocated to storage operations of the type meet or exceed the operation concurrency limit; and
responsively skip executing the storage operation by not allocating the worker thread to the storage operation.

8. The computing apparatus of claim 7, wherein the program instructions further direct the one or more processors to determine the operation concurrency limit based on a storage performance metric associated with the application.

9. The computing apparatus of claim 8, wherein the storage performance metric comprises an operation latency metric associated with storage operations of the type.

10. A method of operating a storage controller, the method comprising:
identifying, by the storage controller, a storage operation associated with an application;
identifying, by the storage controller, an available worker thread from a pool of available worker threads for executing the storage operation;
determining, by the storage controller, whether to allocate the available worker thread to the storage operation based on an application concurrency limit associated with the application and based on an operation concurrency limit associated with a type of the storage operation; and
in response to determining to allocate the available worker thread to the storage operation, executing the storage operation using the available worker thread.

11. The method of claim 10, wherein the application concurrency limit indicates how many worker threads can be allocated to storage operations associated with the application.

12. The method of claim 11, wherein the operation concurrency limit indicates how many worker threads allocated to storage operations associated with the application can be allocated to a specific storage operation type.

13. The method of claim 12, wherein determining whether to allocate the available worker thread to the storage operation based on the application concurrency limit associated with the application comprises comparing a number of worker threads allocated to storage operations associated with the application to the application concurrency limit associated with the application.

14. The method of claim 13, wherein determining whether to allocate the available worker thread to the storage operation based on the operation concurrency limit associated with the type of the storage operation comprises comparing a number of worker threads allocated to storage operations of the type to the operation concurrency limit.

15. The method of claim 14, further comprising:
determining that the number of worker threads allocated to the storage operations associated with the application meets or exceeds the application concurrency limit associated with the application; and
responsively skipping executing the storage operation.

16. The method of claim 15, further comprising:
determining that the number of worker threads allocated to storage operations of the type meets or exceeds the operation concurrency limit; and
responsively skipping executing the storage operation.

17. The method of claim 16, wherein:
the operation concurrency limit comprises a value based on a storage performance metric associated with the application, and
the method further comprises determining the storage performance metric.

18. The method of claim 17, wherein:
the storage performance metric comprises an operation latency metric, and
the operation latency metric comprises a measure of a latency between a generation of the storage operation and an execution of the storage operation.

19. One or more computer readable storage media having program instructions stored thereon that, when read and executed by one or more processors of a computing apparatus, direct the computing apparatus to at least:
identify a storage operation associated with an application;
identify an available worker thread from a pool of available worker threads for executing the storage operation,
determine whether to allocate the available worker thread to the storage operation based on an application concurrency limit associated with the application and an operation concurrency limit associated with a type of the storage operation, wherein the operation concurrency limit is determined based on a storage performance metric associated with the storage operations; and
in response to determining to allocate the available worker thread to the storage operation, execute the storage operation using the available worker thread.

20. The one or more computer readable storage media of claim 19, wherein:
the storage performance metric comprises an operation latency metric, and
the operation latency metric comprises a measure of a latency between a generation of the storage operation and an execution of the storage operation.
